(19) United States
(12) Patent Application Publication
(10) Pub. No.: US 2003/0208342 A1
(43) Pub. Date: Nov. 6, 2003

(54) Method and system for providing construction information service

(76) Inventor: Pyoung Young Jung, Seoul (KR)

Correspondence Address: PARK & SUTTON LLP, 3255 WILSHIRE BLVD, SUITE 1110, LOS ANGELES, CA, 90010, US

(21) Appl. No.: 10/138,551

(22) Filed: May 2, 2002

(51) Int. Cl. G06F 17/50

(52) U.S. Cl. 703/1

(57) ABSTRACT

A method for providing construction information service about a structure is provided. The method comprises design data inputting step that inputs design data that comprises two-dimensional drawings that illustrate construction elements of the structure, design data analyzing step that comprises analyzing the drawings to extract geometrical data of the construction elements and reading engineering data of the construction elements, reference data retrieving step that retrieves reference data related to the construction elements from a database, information producing step that produces construction information from the geometrical data and the engineering data analyzed from the drawings and the reference data retrieved from a database, and information outputting step that outputs the construction information. The geometrical data of the structure comprise shapes and locations of the construction elements and the engineering data of the structure comprise materials, and processes for making the construction elements.

### BACKGROUND OF THE INVENTION

The present invention relates to a method for providing building and construction information service over communication network. More particularly, the invention relates to a method for providing such information online by extracting data from computerized drawings and generating information based on the extracted data and reference data from a database.

Generally, a specification for construction or manufacture of a building or other structures is prepared by making design drawings including structural drawings, building drawings, and facility drawings, analyzing the drawings to get data for estimating the construction cost, and to calculate the detail cost for each construction material or construction process from the data. Construction of a building or a structure proceeds based on the specification.

Using CAD (Computer Aided Design) program is now common for making building or construction drawings. However, even for drawings made by using a CAD program, analyzing drawings was done manually. In the manual operation, an operator checks each construction material and each construction process illustrated on the drawings, estimates the amounts of construction materials or elements, and calculates the cost using an electronic calculator or a program for that purpose. The manual operation takes a long time even with multiple operators.

Substantial reduction in construction period and construction cost would be possible by automating the analysis step of the drawings.

There have been efforts to overcome the disadvantage of the manual operation for calculating the amounts and the unit costs for construction elements required for construction of a building or other structures, by automating the operation with computer. Since drawings made using CAD programs are ready to be read by a computer, it would be advantageous to integrate the drawings as input data for computer software that provides construction cost and process information. Drawings made using CAD programs are stored as electronic data files, and the files can be transferred over electronic communication network such as a local are network (LAN) or the Internet. In this way, drawings can be shared between departments, offices, or companies, and communication about drawings would be greatly facilitated.

It would be advantageous to provide a total management service system for the entire construction process of a structure that covers design, supply, and construction, etc., and that interconnects the designer, supplier, constructor, and vendors, etc over the communication network.

### SUMMARY OF THE INVENTION

An object of the invention is to provide a method for automatically providing building and construction information from computerized drawings.

Another object of the invention is to provide a method of receiving construction data over an electronic network, processing the data automatically, and providing construction information over the network.

Still another object of the invention is to provide a method of providing construction information that can be adjusted and customized interactively.

Still another object of the invention is to provide a method of integrating data from drawings and databases that store data for construction materials, construction processes and costs thereof.

Still another object of the invention is to provide a method of automatically analyzing material, shape, location, and cost for construction elements, and producing construction specification to manage the construction process.

Still another object of the invention is to provide a method of displaying virtual reality image by processing geometrical data from drawings and construction material and process data from databases.

Still another object of the invention is to provide a computer system for receiving construction data over an electronic network, processing the data automatically, and providing construction information over the network.

To achieve the above-described objects, the invention provides a method for providing construction information service about a structure. The method comprises an inputting step that inputs design data that comprises two-dimensional drawings that illustrate construction elements of the structure, an analyzing step that comprises analyzing the drawings to extract geometrical data of the construction elements and reading engineering data of the construction elements, a retrieving step that retrieves reference data related to the construction elements from a database, a producing step that produces construction information from the geometrical data and the engineering data analyzed from the drawings and the reference data retrieved from a database, and an outputting step that outputs the construction information. The geometrical data of the structure comprise numbers, shapes and locations of the construction elements and the engineering data of the structure comprise materials, and processes for making the construction elements. The reference data comprise costs and period requirements for the construction elements. The construction information comprises a construction specification. The design data may be stored in the database for later access.

The analyzing step may further comprise assigning predetermined codes to the construction elements, and the retrieving step uses the codes to retrieve reference data related to the construction elements.

All of the steps of the method of the present invention may be sequentially repeated on the request of a user of the method. The steps may be performed for a basic set of drawings to give the user a rough estimate and opportunities of modifying the basic drawings and requesting to recalculate the estimate. Then the steps may be performed for a set of detail drawings to produce a detailed construction specification.

The engineering data of the structure may further comprise use and size of the structure, and the reference data stored in the database are classified according to the use and size of the structure.

The analyzing step may further comprise a font conversion step that converts fonts of the design data into predetermined fonts. The font conversion step comprises the steps of identifying fonts of the drawings of the design data, comparing the fonts of the design data with a predetermined font, and converting the fonts of the design data into the predetermined font in case that the fonts of the design data are different from the predetermined font.

The analyzing step may further comprise manual intervention step for handling objects in the drawings, which are not analyzed automatically.

The method of the present invention may be implemented in a stand-alone computer. The major purpose of the method of the present invention is to process and share data related to construction of a structure or a building between multiple entities such as designers, vendors, and suppliers, etc. using an electronic communication network such as the Internet. In this case, the inputting step inputs the design data over the network, and the outputting step outputs the construction information over the network. The inputting step and the outputting step use a web site to input the design data, and to output the construction information, respectively. The web site may comprise an e-mail service, a chatting service, and a user authentication service.

The present invention also provides a computer system for providing construction information service about a structure. The system comprises a data handling module, a database and an information process module. The data handling module receives input data from users of the system and sends output data to the users. The input data are design data that comprises two-dimensional drawings that illustrate construction elements of the structure. The output data are construction information for the structure. The information process module comprises an analyzing module, a reference data retrieving module, and an information producing module. The analyzing module analyzes the drawings to extract geometrical data of the construction elements and to read engineering data of the construction elements. The reference data retrieving module retrieves reference data related to the construction elements from the database. The information producing module produces construction information from the geometrical data and the engineering data analyzed from the drawings and the reference data retrieved from the database. The geometrical data of the construction elements comprise numbers, shapes and locations of the construction elements and the engineering data of the construction elements comprise materials, and processes for making the construction elements. The output data comprise the construction information produced by the information process module.

The analyzing module may assign predetermined codes to the construction elements, and the reference data retrieving module uses the codes to retrieve reference data related to the construction elements.

The system may further comprise a management module that allows manual intervention for the information process module.

The information process module may further comprise a font conversion module that converts fonts of the two-dimensional drawings into predetermined fonts.

All of the modules of the system may be interconnected with an electronic communication network and the data handling module may be a web server that hosts a web site for the system. The web server may comprise an e-mail module, a chatting module, and a user authentication module. The system may further comprise an electronic money transfer module.

The advantages of the present invention are numerous in that: (1) the time required for producing a construction specification for a structure starting from analyzing drawings for the structure can be reduced substantially; (2) optimization of design for a structure is greatly facilitated by modifying drawings and checking the modified construction specification including the cost and period instantly; (3) construction data for a structure including drawings for the structure and for each construction element of which the structure consists, and the data analyzed from the drawings can be instantly shared between entities related to the construction; and (4) visualization of the process constructing a structure according to time scale can be easily achieved using the computerized drawings and with their related data.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic diagram showing the construction information service system of the present invention;

FIG. 2 is a schematic diagram showing a user interface for the construction information service system;

FIG. 3 is a flow chart showing the basic steps for the construction information service method of the present invention;

FIG. 4 is a flow chart showing a font conversion step; and

FIG. 5 is a flow chart showing the detailed steps for the construction information service method of the present invention.

### DETAILED DESCRIPTION OF THE PREFERRED EMBODIMENTS

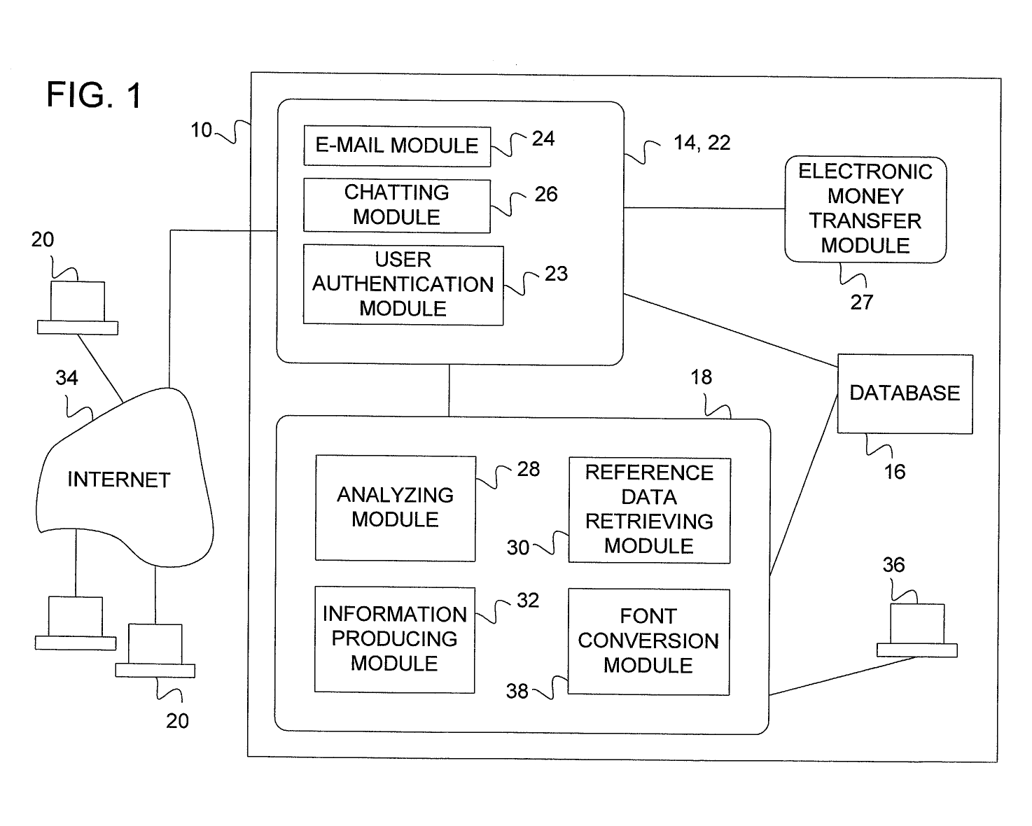

As shown in FIG. 1, a computer system for providing construction information service about a structure 10 of the present invention has a data handling module 14, a database 16, and an information process module 18.

The users of the system 10 communicate with the system 10 using terminals 20. The terminals 20 send input data such as drawings from users of the system 10, and display output data such as construction information for a structure from the system 10. The data handling module 14 handles the transfer of the input data from the terminals 20 to other modules of the system 10 and the output data from the system 10.

The input data are design data for a structure, which include two-dimensional or three-dimensional drawings that illustrate construction elements of the structure. The terminals 20 receive requests from users for construction information. The requests include requirements for the structure such as construction cost, which also form part of the input data.

The system 10 may be implemented in a stand-alone computer. However, the system 10 is mainly intended for using an electronic communication network such as the Internet to interconnect entities including designers, vendors, and suppliers for construction. Thus, all of the modules of the system 10 are interconnected by networking, and the data handling module 14 is a web server 22 that hosts a website for the system 10. The web server 22 receives the input data from the terminals 20 and sends the output data to the terminals 20 for displaying the data to users of the system 10. The web server 22 also includes a user authentication module 23 for allowing only valid users to use the system 10, an email module 24 for handling e-mails between the users and the system 10, and a chatting module 26 for providing interactive communication between the users and the system 10. An electronic money transfer module 27 is connected to the web server 22 for paying the construction cost electronically according to a paying request via the web server 22. The web server 22 transfers the input data to the information process module 18 for analysis. The information process module 18 transfers the produced construction information to the web server 22, and the web server 22 send the information to the users as web page display, downloadable files, or e-mail attachments.

The terminals 20 are computers that have a CAD (computer aided design) program installed within them so that the user can make or modify construction drawings, and networking devices such as a modem or a LAN card to communicate with the system 10 through the Internet 34. The users use an internet browser such as Microsoft Internet Explorer, Netscape Communicator, or a dedicated web browsing program to connect to the system 10, and exchange information with the system 10. The terminals 20 send two-dimensional drawings for analysis by uploading in web pages of the web site of the system 10, or as attachments of e-mail.

The information process module 18 includes an analyzing module 28, a reference data retrieving module 30, and an information producing module 32.

The analyzing module 28 analyzes the drawings to extract geometrical data of the construction elements and to read engineering data of the construction elements. The reference data retrieving module 30 retrieves reference data related to the construction elements from the database 16. The information producing module 32 produces construction information from the geometrical data and the engineering data analyzed from the drawings and the reference data retrieved from the database 16. The geometrical data of the construction elements comprise numbers, shapes and locations of the construction elements and the engineering data of the construction elements comprise materials, and processes for making the construction elements, and use and size of the structure. The output data comprise the construction information produced by the information process module 18.

The analyzing module 28 analyzes drawings that have been input to the system 10. Computer software of other references may be used to perform the functions of the analyzing module 28. Examples of such other references are Korean patent laid-open (pre-grant) publications 2001-0007818 and 2001-0007820. They disclose methods for extracting geometrical data of construction elements illustrated in the drawings.

The analyzing module 28 assigns predetermined codes to the construction elements analyzed from the drawings, and the reference data retrieving module 30 uses the codes in retrieving reference data related to the construction elements from the database 16.

The information producing module 32 uses the reference data retrieved from the database 16 to calculate cost and period requirements for each construction element and for the entire structure. The information producing module 32 may also include other information such as vendors, suppliers, and product names of the construction elements, etc. in the construction information. The produced construction information includes data classified according to construction elements, construction process, vendors, and suppliers, etc.

The system 10 further comprises a management module 36 that allows manual intervention for the information process module 18 and manages the operation of the information process module 18. The management module 36 handles construction elements having irregular shapes that are difficult to be automatically processed by the analyzing module 28. The management module 36 also performs manual adjustment of environmental parameters for extracting geometrical data from the drawings, and inputting height of a structure so that a three-dimensional object can be generated with data analyzed from two-dimensional drawings and the height.

The information process module 18 further comprises a font conversion module 38 that converts fonts of the drawings into predetermined fonts. There are varieties of CAD programs that use their own set of fonts. When the sets of fonts are not compatible with one another, loss of information in texts of the drawings or illegible display of the texts may happen. The font conversion module 38 automatically converts fonts of the drawings of the input data into a predetermined font used by the analyzing module 28 so that the data contained in texts in the drawings are successfully read in the analyzing module 28 and texts in construction information are legible.

The database 16 stores reference data for wide variety of construction elements, fonts data, and the input data from the terminals 20 so that when the users connect to the system 10 again, the users can use the service provided by the system 10 without resending the same input data. The reference data are classified according to use and size of the structure so that they can be readily retrieved to produce construction specification for the structure. The reference data also include costs and period requirements for the construction elements, and properties for the construction elements such as appearance, material and manufacture or construction process for the elements. The reference data for construction elements are also classified by codes so that the analyzing module 28 and the reference data retrieving module 30 can use the codes for their operation. The input data and construction information for a structure processed by the system 10 are also stored in the database 16 so that the user of the system 10 can readily access his or her data upon a proper user authentication of the user.

The construction information comprises a construction specification. The construction specification includes all information required for performing construction of a specific structure, such as name, cost, appearance and amount for each construction element, the period of incorporating the element within the structure, the order of incorporating construction elements, the total cost and period for completing the entire structure, etc.

The construction information may also comprise four dimension virtual reality data for the structure. A three dimensional object is generated using the construction element data analyzed from the two-dimensional drawings, the reference data for the construction elements, and a height data provided by the user or the management module 36. Time is added as the fourth dimension. That is, the appearance of each of the construction elements is changed according to proceedings of construction period of the element, and the order of the element within the total construction process of the entire structure.

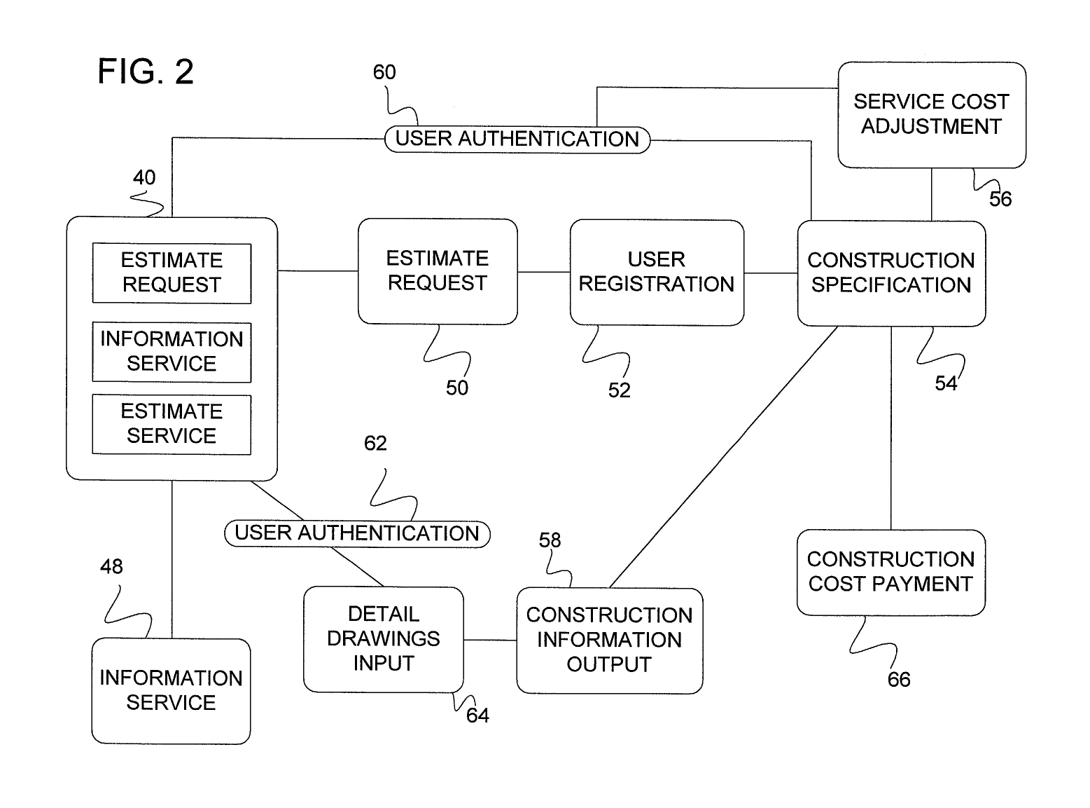

As shown in FIG. 2, the user interface of the website for the system 10 includes a starting web page 40. The starting web page 40 includes estimate request hypertext 42, information service hypertext 44, and estimate service hypertext 46.

The information service hypertext 44 is linked to an information service page 48. The information service page 48 includes web pages discloses information about vendors for building, construction, and facilities, etc, construction materials, construction equipments, and available manpower.

The estimate request hypertext 42 is linked to an estimate request page 50. The estimate request page 50 includes a basic estimate request page based on basic drawings, which inputs use and size of a structure and basic drawings for the structure, an e-mail page for sending drawings by e-mail, and a service cost suggest page through which the user can suggest service cost to the system 10.

The estimate request page 50 is linked to a user registration page 52. When there is an estimate request from a user in the estimate request page 50, the user registration page 52 grant the user a user identification number to provide a secure connection for the user about the estimate request.

The user registration page 52 is linked to a construction specification page 54. The construction specification page 54 includes a total service cost page that displays the total cost for a constructing a structure, a detail service cost page that displays detail cost information, and a service cost adjustment hypertext for adjusting the construction service cost. The construction specification page 54 displays service cost calculated based on the use and size of the structure and basic drawings for the structure that are submitted via the basic estimate request page of the estimate request page 50.

The service cost adjustment hypertext of the construction specification page 54 is linked to a service cost adjustment page 56. The service cost adjustment page 56 includes a service cost display page that displays service cost adjusting status and the result in real time, a chatting service page that allows interactive exchange of service cost adjustment information between the user and the system 10 via text or voice chatting, and an e-mail hyperlink to exchange service cost adjustment information by e-mail. Real time adjustment of service cost is possible with the chatting and e-mail service of the service cost adjustment page 56.

A construction information output page 58 is linked to the construction specification page 54. When the final decision for the service cost is done in the service cost adjustment page 56, the construction specification produced by the information process module 18 is sent in the construction information output page 58 as e-mail to the user's computer.

A user authentication page 60 is provided between the starting web page 40 and the construction specification page 54. The user authentication page 60 allows the user to link directly to the construction specification page 54 and the service cost adjustment page 56 upon user authentication by checking that a correct user identification number is typed, so that when a user reconnects to the website of the system 10 after using and disconnecting from the website of the system 10, he or she can readily perform retrieving the construction specification and adjusting service cost.

A detail drawings input page 64 is linked to the starting web page 40 via a user authentication page 62. The user can upload detail drawings to a storage space in the detail drawings input page 64 in case the detail drawings were not already sent as e-mail in the estimate request page 50. The detail drawings input page 64 is linked to the construction information output page 58.

The construction specification page 54 is linked to a construction cost payment page 66 to pay the service cost in predetermined methods such as using credit card, or electronic deposit.

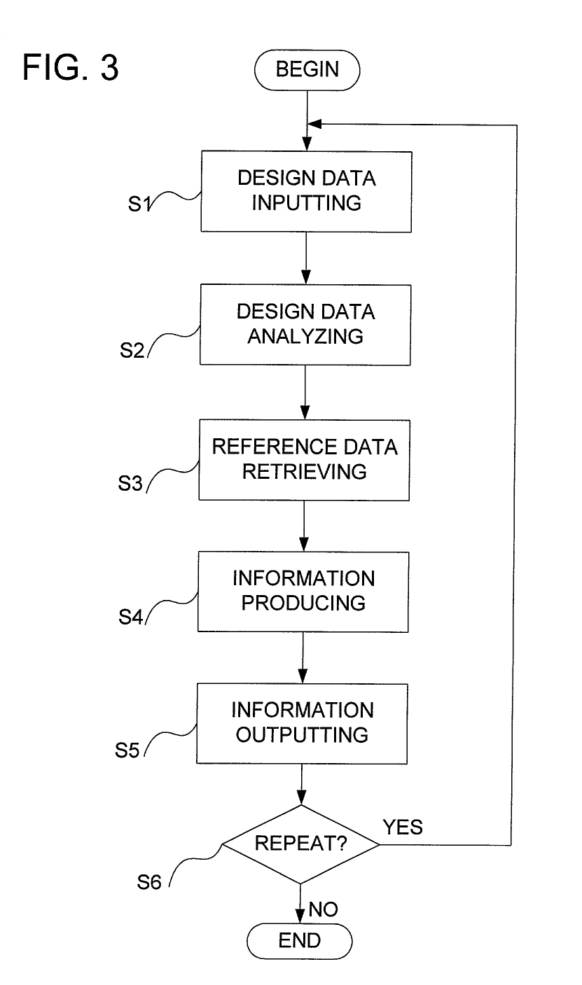

As shown in FIG. 3, a method for providing construction information service about a structure of the present invention comprises design data inputting step S1, design data analyzing step S2, reference data retrieving step S3, information producing step S4, and information outputting step S5.

The design data inputting step S1 inputs the design data to the computer system 10. The design data analyzing step S2 comprises analyzing the drawings to extract geometrical data of the structure and reading engineering data of the structure. The design data analyzing step S2 assigns predetermined codes to the construction elements. The reference data retrieving step S3 retrieves the reference data related to the construction elements from the database 16 using the codes assigned in the design data analyzing step S2. The information producing step S4 produces construction information from the geometrical data and the engineering data analyzed from the drawings and the reference data retrieved from the database 16. The information outputting step S5 outputs the construction information.

All of the steps S1-S5 may be repeated upon the request of the user of the method, and hence the system 10. Step S6 asks the user whether she or he wants to repeat the method. For all of the steps, data transfer may be performed with an electronic communication network such as the Internet. Specifically, the design data inputting step S1 and the information outputting step S5 uses the web site of the system 10 to input the design data, and to output the construction information, respectively.

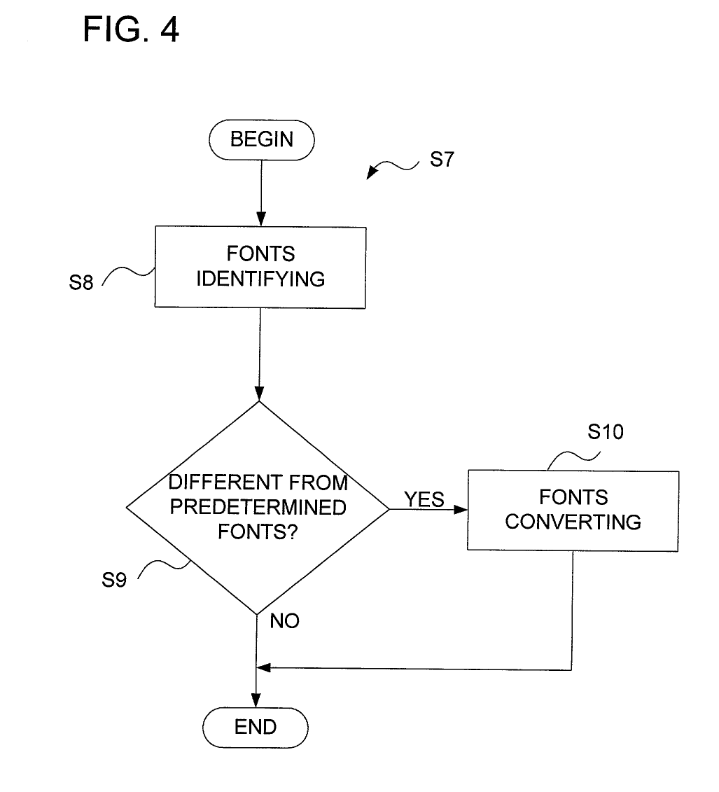

The design data analyzing step S2 further comprises font conversion step S7 that converts fonts of the design data into predetermined fonts. As shown in FIG. 4, the font conversion step S7 comprises font identifying step S8 that identifies fonts of the drawings of the design data, font comparing step S9 that compares the fonts of the design data with predetermined fonts, and fonts converting step S10 that converts the fonts of the design data into the predetermined font in case that the fonts of the design data are different from the predetermined font.

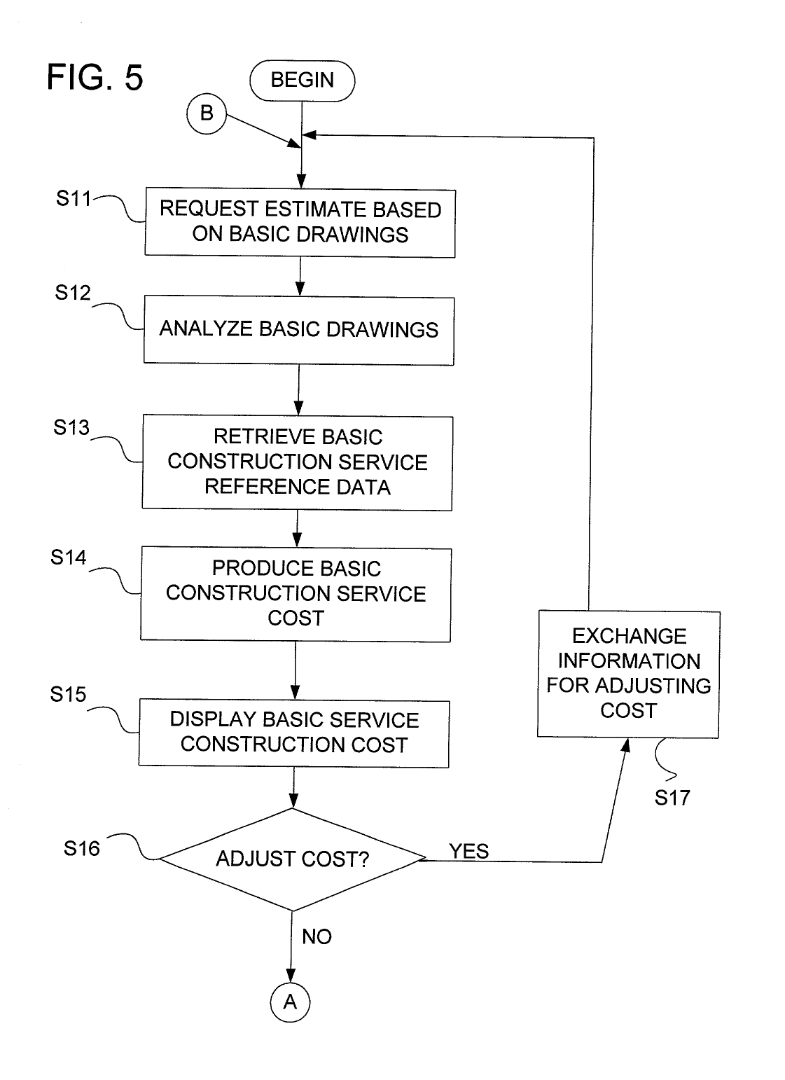

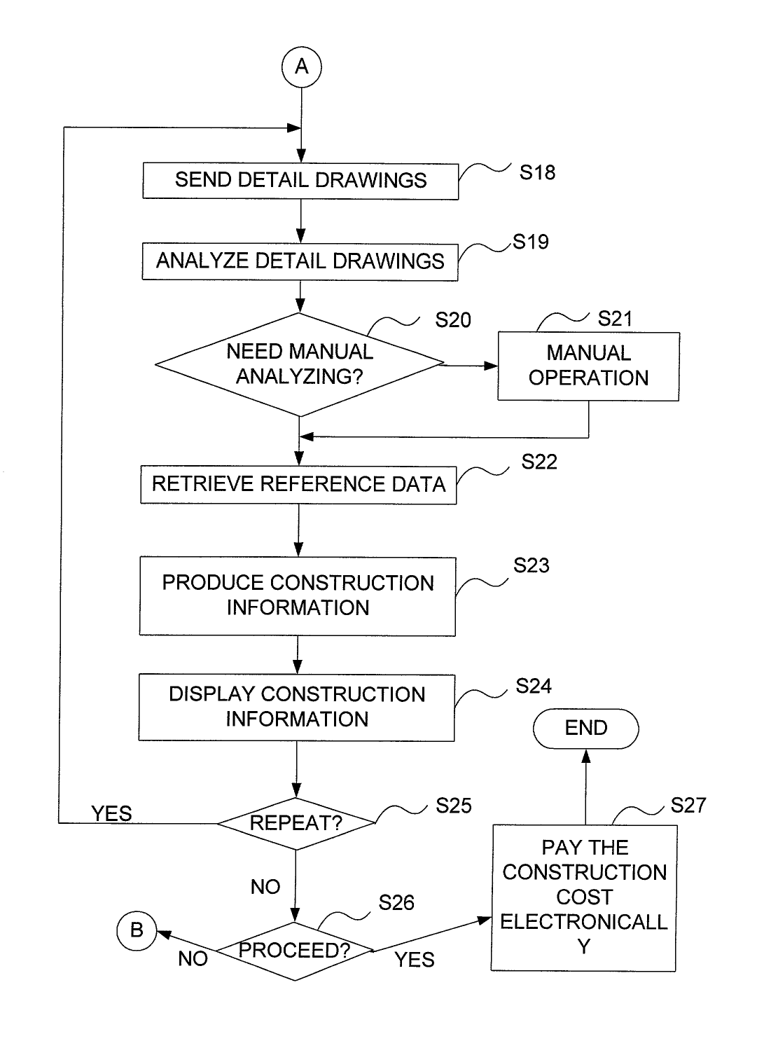

FIG. 5 shows the method of the present invention in detail. In step S11, the user places a request for a construction cost estimate. The user first launches a web browser to connect to the web server 22 of the system 10 via the Internet 34. Then the user sends the required information for placing an estimate request, which includes two-dimensional drawings for a structure, information about the use and size of the structure, and a service cost suggestion. Basic drawings for a rough estimate are usually sent but it is also possible to send full detail drawings. When there is an estimate request, the web server 22 grants the user a user identification number for the request.

In step S12, the basic drawings are analyzed to extract the geometrical data and the engineering data of the construction elements of the structure illustrated by the basic drawings.

In step S13, reference data, which are related to the analyzed data from step S12, are retrieved from the database 16.

In step S14, basic construction service cost is calculated using the analyzed data form step S12 and the reference data retrieved in step S13.

In step S15, the calculated cost is sent to the terminal 20 and displayed on the screen of the terminal 20.

In step S16, the user decides whether the calculated cost needs to be adjusted or not. If adjustment is not needed, the method proceeds to step S18. Otherwise, the method proceeds to step S17.

In step S17, information exchange to guide cost adjustment is performed interactively between the user and the system 10 with web pages, e-mail service or chatting service provided by the web server 22. Then the method proceeds to step S11, and the user inputs modified drawings or other modified data. Steps S11-S16 are repeated for the modified input data.

After completion of this basic construction service cost adjustment process, in step S18, the user sends detail drawings by uploading or e-mail to the web server 22, and the web server 22 sends the detail drawings to the information process module 18.

In step S19, the detail drawings are analyzed to extract the geometrical data and the engineering data of the construction elements of the structure illustrated by the detail drawings.

In step S20, the information process module 18 decides whether there are irregular shapes in the drawings, which need manual operation, and whether manual adjustment of parameters for analyzing drawings is needed. If manual operation is needed, the method proceeds to step S21. Otherwise, the method proceeds to step S22.

In step S21, the management module 36 performs manual operation such as manually inputting parameters, analyzing or selecting reference data for the irregular shapes, and the information process module 18 uses the data input manually by the management module 36. Thus step S21 provides a manual intervention step for the design data analyzing step S2.

In step S22, reference data, which are related to the analyzed data from step S19, are retrieved from the database 16.

In step S23, the information process module 18 produces the construction specification.

In step S24, the construction specification is sent by e-mail to the terminal 20.

In step S25, the web server 22 asks the user whether the construction specification is acceptable. If the user selects to repeat steps S18-S24 to modify the detail drawings and to get a modified construction specification, the method goes back to step S18. Otherwise, the method proceeds to step S26.

In step S26, the web server 22 asks the user whether he or she wants to repeat the entire steps S11-S24. If the user selects to repeat the steps S11-S24, the method goes back to step S11. Otherwise, the method proceeds to step S27.

In step S27, the user can pay the construction service cost with the electronic money transfer module 27.

The web server 22 may host a separate website which does not perform user authentication and provides construction information service for anonymous users.

With the above system and method, the time between the user's submission of drawings and providing a construction specification is reduced substantially, and cost and period requirements can be readily fed back for design modification. Also, real time sharing of construction data can reduce the construction period substantially, and improve productivity.

Although the invention has been described in considerable detail, other versions are possible by converting the aforementioned construction. Therefore, the scope of the invention shall not be limited by the specification specified above and the appended claims.

What is claimed is:

1. A method for providing construction information service about a structure comprising:
a) inputting design data, wherein the design data comprises two-dimensional drawings that illustrate construction elements of the structure;
b) analyzing design data, wherein the analyzing step comprises analyzing the drawings to extract geometrical data of the construction elements and reading engineering data of the construction elements;
c) retrieving reference data related to the construction elements from a database;
d) producing construction information from the geometrical data and the engineering data analyzed from the drawings and the reference data retrieved from a database; and
e) outputting the construction information;
wherein the geometrical data of the structure comprise numbers, shapes and locations of the construction elements and the engineering data of the structure comprise materials, and processes for making the construction elements.

2. The method claim 1 wherein the analyzing step further comprises assigning predetermined codes to the construction elements, and the retrieving step uses the codes to retrieve reference data related to the construction elements.

3. The method of claim 1 wherein the inputting step, the analyzing step, the retrieving step, the producing step, and the outputting step are sequentially repeated on the request of a user of the method.

4. The method of claim 1 wherein the reference data comprise costs and period requirements for the construction elements.

5. The method of claim 1 wherein the construction information comprises a construction specification.

6. The method of claim 1 wherein the engineering data of the structure further comprises use and size of the structure, and the reference data stored in the database are classified according to the use and size of the structure.

7. The method of claim 1 wherein the design data are stored in the database.

8. The method of claim 1 wherein the analyzing step further comprises font conversion step that converts fonts of the design data into predetermined fonts, wherein the font conversion step comprises:
a) identifying fonts of the drawings of the design data;
b) comparing the fonts of the design data with a predetermined font; and
c) converting the fonts of the design data into the predetermined font in case that the fonts of the design data are different from the predetermined font.

9. The method of claim 1 wherein the analyzing step further comprises a manual intervention step.

10. The method of claim 1 wherein the inputting step inputs the design data over an electronic communication network, and the outputting step outputs the construction information over an electronic communication network.

11. The method of claim 10 wherein the electronic communication network comprises Internet, and wherein the inputting step and the outputting step use a web site to input the design data, and to output the construction information, respectively.

12. The method of claim 11 wherein the web site comprises an e-mail service.

13. The method of claim 11 wherein the web site comprises a chatting service.

14. The method of claim 11 wherein the web site comprises a user authentication service.

15. A computer system for providing construction information service about a structure comprising:
a) a data handling module that receives input data from users of the system and sends output data to the users;
b) a database; and
c) an information process module;
wherein the input data are design data that comprise two-dimensional drawings that illustrate construction elements of the structure;
wherein the information process module comprises an analyzing module, a reference data retrieving module, and an information producing module; wherein the analyzing module analyzes the drawings to extract geometrical data of the construction elements and to read engineering data of the construction elements;
wherein the reference data retrieving module retrieves reference data related to the construction elements from the database;
wherein the information producing module produces construction information from the geometrical data and the engineering data analyzed from the drawings and the reference data retrieved from the database; and
wherein the geometrical data of the construction elements comprise numbers, shapes and locations of the construction elements and the engineering data of the construction elements comprise materials, and processes for making the construction elements; and wherein the output data comprise the construction information produced by the information process module.

16. The computer system of claim 15 wherein the analyzing module assigns predetermined codes to the construction elements, and the reference data retrieving module uses the codes to retrieve reference data related to the construction elements.

17. The computer system of claim 15 wherein the system further comprises a management module that allows manual intervention for the information process module.

18. The computer system of claim 15 wherein the information process module further comprises a font conversion module that converts fonts of the two-dimensional drawings into predetermined fonts.

19. The computer system of claim 15 wherein the data handling module, the database, and the information process module are interconnected with an electronic communication network.

20. The computer system of claim 19 wherein the system further comprises an electronic money transfer module.

21. The computer system of claim 19 wherein the data handling module is a web server that hosts a web site for the system.

22. The computer system of claim 21 wherein the web server comprises an e-mail module, a chatting module, and a user authentication module.
